(19) United States
(12) Patent Application Publication
(10) Pub. No.: US 2002/0078098 A1
(43) Pub. Date: Jun. 20, 2002

(54) Document filing method and system

(75) Inventor: Akiko Shirai, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/020,415

(22) Filed: Dec. 18, 2001

(30) Foreign Application Priority Data
Dec. 19, 2000 (JP) 2000-385461

(51) Int. Cl. G06F 15/00

(52) U.S. Cl. 707/517

(57) ABSTRACT

In a document filing system, document filing method, and recording medium, an image input section inputs page image information of a document. A graphic pattern extraction section extracts a graphic pattern area from the input page image information. A graphic pattern layout classification section classifies the graphic pattern area on the basis of layout classification criteria defined in advance. An information storing section stores a layout classification classified by the graphic pattern layout classification section upon linking the layout classification to the page image information input by the image input section. A command input section gives a command to search for page image information by designating layout information of a graphic pattern in the page image information as a rectangle in a frame on a paper sheet. A search processing section classifies the rectangle in the frame on the paper sheet on the basis of the layout classification criteria, and searches for page image information stored upon being linked to the same layout classification. An image display section displays the page image information searched out by the search processing section.

### BACKGROUND OF THE INVENTION

1. Field of the Invention

The present invention relates to a document filing method and system and, more particularly, to a document filing method and system for filing documents as page image information on a page basis.

2. Description of the Prior Art

In conventional document filing systems, the following method is known. First of all, a keyword is input at the time of registration of page image information, and the keyword and page image information are linked and stored. In searching for the page image information afterward, the keyword is designated as a search condition.

A document filing system used to search for a graphic pattern or color is disclosed in Japanese Unexamined Patent Publication No. 62-279468. In this system, an arbitrary color pattern is input at the time of registration of page image information, and the color pattern and page image information are linked and stored to allow a user to search for the page image information by designating the color pattern.

These conventional techniques, however, suffer the following problems.

First, it takes much time to register page image information. This is because pieces of search information such as keywords, color patterns, and the like are input manually.

Second, the user cannot reach target page image information unless he/she inputs an accurate keyword or color pattern. This is because keywords or color patterns that are subjectively determined by users are used as search conditions.

### SUMMARY OF THE INVENTION

The present invention has been made in consideration of the above situation and, has as its object to provide a document filing method and system which can designate the layout (positions and sizes) of drawings and tables (to be generically graphic patterns hereinafter) contained in page image information as search conditions.

It is another object of the present invention to provide a document filing method and system which can designate the colors of rectangles, which are designated as graphic pattern layout classifications, as search conditions.

In order to achieve each of the above objects, according to the first main aspect of the present invention, there is provided a document filing system comprising an image input section for inputting page image information of a document, a graphic pattern extraction section for extracting a graphic pattern area from the page image information input by the image input section, a graphic pattern layout classification section for classifying the graphic pattern area extracted by the graphic pattern extraction section on the basis of layout classification criteria defined in advance, an information storing section for storing a layout classification from the graphic pattern layout classification section upon linking the layout classification to the page image information input by the image input section, a command input section for giving a command to search for page image information by designating layout information of a graphic pattern in the page image information as a rectangle in a frame on a paper sheet, a search processing section for classifying the rectangle in the frame on the paper sheet, which is designated by the command input section, on the basis of the layout classification criteria, and searching for page image information stored upon being linked to the same layout classification, and an image display section for displaying the page image information searched out by the search processing section.

According to the second main aspect of the present invention, there is provided a document filing system comprising an image input section for inputting page image information of a document, graphic pattern extraction section for extracting a graphic pattern area from the page image information input by the image input section, a graphic pattern layout classification section for classifying the graphic pattern area extracted by the graphic pattern extraction section on the basis of layout classification criteria defined in advance, a color acquisition section for acquiring a representative color from the graphic pattern area extracted by the graphic pattern extraction section, a color classification section for classifying the color from the color acquisition section on the basis of color criteria defined in advance, an information storing section for linking a layout classification obtained by the graphic pattern layout classification section to a color classification obtained by the color classification section and storing the classifications upon linking the classifications to the page image information input by the image input section, a command input section for giving a command to search for page image information by designating layout information of a graphic pattern in the page image information as a rectangle in a frame on a paper sheet, and also designating a color for a search with respect to the designated rectangle on the basis of the color criteria, a search processing section for classifying the rectangle in the frame on the paper sheet, which is designated by the command input section, on the basis of the layout classification criteria, searching for page image information stored upon being linked to the same layout classification, and narrowing down the page image information as a search result depending on whether the information is stored upon being linked to the same color classification as that of the color designated by the command input section, and an image display section for displaying the page image information narrowed down by the search processing section.

According to the third main aspect of the present invention, there is provided a document filing system comprising an image input section for inputting page image information of a document, graphic pattern extraction section for extracting a graphic pattern area from the page image information input by the image input section, a graphic pattern layout classification section for classifying the graphic pattern area extracted by the graphic pattern extraction section on the basis of layout classification criteria defined in advance, a color acquisition section for acquiring a representative color from the graphic pattern area extracted by the graphic pattern extraction section, a color classification section for classifying the color from the color acquisition section on the basis of color criteria defined in advance, an information storing section for linking a layout classification obtained by the graphic pattern layout classification section to a color classification obtained by the color classification section and storing the classifications upon linking the classifications to the page image information input by the image input section, a first command input section for giving a command to search for page image information by designating layout information of a graphic pattern in the page image information as a rectangle in a frame on a paper sheet, a first search processing section for classifying the rectangle in the frame on the paper sheet, which is designated by the first command input section, on the basis of the layout classification criteria, and searching for page image information stored upon being linked to the same layout classification, a first image display section for displaying the page image information searched out by the first search processing section, a second input section for inquiring whether to narrow down the page image information displayed by the first image display section by colors, and if the information is to be narrowed down by colors, giving a command to narrow down the page image information by designating a color to be searched out with respect to each rectangle on the basis of the color classification criteria, a second search processing section for narrowing down the page image information searched out by the first search processing section depending on whether the information is stored upon being linked to the same color classification as that of each rectangle designated by the second command input section, and a second image display section for displaying the page image information narrowed down by the second search processing section.

According to a secondary aspect of the present invention, the document filing system according to any one of the first to third main aspects further comprises a section for selecting a portrait/landscape orientation of the paper sheet at the time of a search for the page image information.

In order to achieve each of the above objects, according to the fourth main aspect of the present invention, there is provided a document filing method comprising the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the information storing step of storing a layout classification from the graphic pattern layout classification step upon linking the layout classification to the page image information input in the image input step, the command input step of giving a command to search for page image information by designating layout information of a graphic pattern in the page image information as a rectangle in a frame on a paper sheet, the search processing step of classifying the rectangle in the frame on the paper sheet, which is designated in the command input step, on the basis of the layout classification criteria, and searching for page image information stored upon being linked to the same layout classification, and the image display step of displaying the page image information searched out in the search processing step.

According to the fifth aspect of the present invention, there is provided a document filing method comprising the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the color acquisition step of acquiring a representative color from the graphic pattern area extracted in the graphic pattern extraction step, the color classification step of classifying the color from the color acquisition step on the basis of color criteria defined in advance, the information storing step of linking a layout classification obtained in the graphic pattern layout classification step to a color classification obtained in the color classification step and storing the classifications upon linking the classifications to the page image information input in the image input step, the command input step of giving a command to search for page image information by designating layout information of a graphic pattern in the page image information as a rectangle in a frame on a paper sheet, and also designating a color for a search with respect to the designated rectangle on the basis of the color criteria, the search processing step of classifying the rectangle in the frame on the paper sheet, which is designated in the command input step, on the basis of the layout classification criteria, searching for page image information stored upon being linked to the same layout classification, and narrowing down the page image information as a search result depending on whether the information is stored upon being linked to the same color classification as that of the color designated in the command input step, and the image display step of displaying the page image information narrowed down in the search processing step.

According to the sixth aspect of the present invention, there is provided a document filing method comprising the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the color acquisition step of acquiring a representative color from the graphic pattern area extracted in the graphic pattern extraction step, the color classification step of classifying the color from the color acquisition step on the basis of color criteria defined in advance, the information storing step of linking a layout classification obtained in the graphic pattern layout classification step to a color classification obtained in the color classification step and storing the classifications upon linking the classifications to the page image information input in the image input step, the first command input step of giving a command to search for page image information by designating layout information of a graphic pattern in the page image information as a rectangle in a frame on a paper sheet, the first search processing step of classifying the rectangle in the frame on the paper sheet, which is designated in the first command input step, on the basis of the layout classification criteria, and searching for page image information stored upon being linked to the same layout classification, the first image display step of displaying the page image information searched out in the first search processing step, the second input step of inquiring whether to narrow down the page image information displayed in the first image display step by colors, and if the information is to be narrowed down by colors, giving a command to narrow down the page image information by designating a color to be searched out with respect to each rectangle on the basis of the color classification criteria, the second search processing step of narrowing down the page image information searched out in the first search processing step depending on whether the information is stored upon being linked to the same color classification as that of each rectangle designated in the second command input step, and the second image display step of displaying the page image information narrowed down in the second search processing step.

According to a secondary aspect of the present invention, the document filing method according to any one of the fourth to sixth main aspects further comprises the step of selecting a portrait/landscape orientation of the paper sheet at the time of a search for the page image information.

In order to achieve each of the above objects, according to the seventh main aspect of the present invention, there is provided a recording medium on which a program is recorded, the program causing a computer to execute the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the information storing step of storing a layout classification from the graphic pattern layout classification step upon linking the layout classification to the page image information input in the image input step, the command input step of giving a command to search for page image information by designating layout information of a graphic pattern in the page image information as a rectangle in a frame on a paper sheet, the search processing step of classifying the rectangle in the frame on the paper sheet, which is designated in the command input step, on the basis of the layout classification criteria, and searching for page image information stored upon being linked to the same layout classification, and the image display step of displaying the page image information searched out in the search processing step.

According to the eighth main aspect of the present invention, there is provided a recording medium on which a program is recorded, the program causing a computer to execute the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the color acquisition step of acquiring a representative color from the graphic pattern area extracted in the graphic pattern extraction step, the color classification step of classifying the color from the color acquisition step on the basis of color criteria defined in advance, the information storing step of linking a layout classification obtained in the graphic pattern layout classification step to a color classification obtained in the color classification step and storing the classifications upon linking the classifications to the page image information input in the image input step, the command input step of giving a command to search for page image information by designating layout information of a graphic pattern in the page image information as a rectangle in a frame on a paper sheet, and also designating a color for a search with respect to the designated rectangle on the basis of the color criteria, the search processing step of classifying the rectangle in the frame on the paper sheet, which is designated in the command input step, on the basis of the layout classification criteria, searching for page image information stored upon being linked to the same layout classification, and narrowing down the page image information as a search result depending on whether the information is stored upon being linked to the same color classification as that of the color designated in the command input step, and the image display step of displaying the page image information narrowed down in the search processing step.

According to the ninth main aspect of the present invention, there is provided a recording medium on which a program is recorded, the program causing a computer to execute the image input step of inputting page image information of a document, the graphic pattern extraction step of extracting a graphic pattern area from the page image information input in the image input step, the graphic pattern layout classification step of classifying the graphic pattern area extracted in the graphic pattern extraction step on the basis of layout classification criteria defined in advance, the color acquisition step of acquiring a representative color from the graphic pattern area extracted in the graphic pattern extraction step, the color classification step of classifying the color from the color acquisition step on the basis of color criteria defined in advance, the information storing step of linking a layout classification obtained in the graphic pattern layout classification step to a color classification obtained in the color classification step and storing the classifications upon linking the classifications to the page image information input in the image input step, the first command input step of giving a command to search for page image information by designating layout information of a graphic pattern in the page image information as a rectangle in a frame on a paper sheet, the first search processing step of classifying the rectangle in the frame on the paper sheet, which is designated in the first command input step, on the basis of the layout classification criteria, and searching for page image information stored upon being linked to the same layout classification, the first image display step of displaying the page image information searched out in the first search processing step, the second input step of inquiring whether to narrow down the page image information displayed in the first image display step by colors, and if the information is to be narrowed down by colors, giving a command to narrow down the page image information by designating a color to be searched out with respect to each rectangle on the basis of the color classification criteria, the second search processing step of narrowing down the page image information searched out in the first search processing step depending on whether the information is stored upon being linked to the same color classification as that of each rectangle designated in the second command input step, and the second image display step of displaying the page image information narrowed down in the second search processing step.

According to a secondary aspect of the present invention, in the recording medium according to any one of the seventh to ninth main aspects, a program for further executing the step of selecting a portrait/landscape orientation of the paper sheet at the time of a search for the page image information is recorded on the recording medium.

As is obvious from the respective aspects described above, according to the present invention, the following effects can be obtained.

First, in registering page image information, no search condition such as a keyword or marker need be input. This is because a graphic pattern area is automatically extracted as a partial image at the time of registration of page image information, and the layout information (position and size) of the extracted graphic pattern is stored as a layout classification upon being linked to the page image information.

Second, in searching for page image information, the layout classification (position and size) of a graphic pattern contained in the page image information can be designated as a search condition. This is because the present invention has the means for designating a graphic pattern layout classification as a rectangle serving as a search condition. A search for a document can be made by a graphic pattern such as an image which can be easily kept in mind by intuition.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the arrangement of a document filing system according to the first embodiment of the present invention;

FIG. 2 is a flow chart showing processing at the time of registration of page image information in the document filing system according to the first embodiment of the present invention;

FIG. 3 is a flow chart showing processing at the time of a search for page image information in the document filing system according to the first embodiment of the present invention;

FIG. 4 is a view exemplifying layout classification criteria for graphic patterns in a case where paper sheets are used in portrait orientation in the document filing system according to the first embodiment of the present invention;

FIG. 5 is a view for explaining an example of the process of classifying layout information of graphic patterns in the document filing system according to the first embodiment of the present invention;

FIGS. 6A and 6B are views for explaining a window for paper selection and a window for graphic pattern position designation in the document filing system according to the first embodiment of the present invention;

FIG. 7 is a block diagram showing the arrangement of a document filing system according to the second embodiment of the present invention;

FIG. 8 is a flow chart showing processing at the time of registration of page image information in the document filing system according to the second embodiment of the present invention;

FIG. 9 is a flow chart showing processing at the time of a search for page image information in the document filing system according to the second embodiment of the present invention;

FIG. 10 is a view exemplifying color classification criteria used for collation by a color classification means in the document filing system according to the second embodiment of the present invention;

FIGS. 11A to 11C are views showing a window for paper selection and a window for graphic pattern position designation in the document filing system according to the second embodiment of the present invention;

FIG. 12 is a flow chart showing a modification associated with processing at the time of a search for page image information in the document filing system according to the second embodiment of the present invention;

FIG. 13 is a block diagram showing the arrangement of a document filing system according to the third embodiment of the present invention; and

FIG. 14 is a block diagram showing the arrangement of a document filing system according to the fourth embodiment of the present invention.

### DETAILED DESCRIPTION OF THE PREFERRED EMBODIMENTS

Several preferred embodiments of the present invention will be described in detail below with reference to the accompanying drawings.

(1) First Embodiment

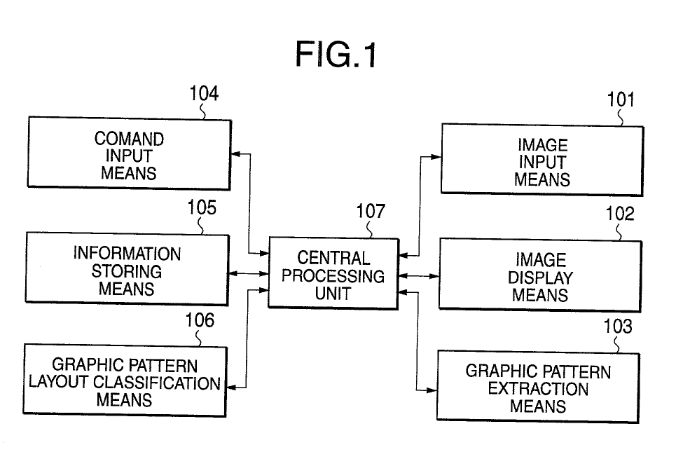

Referring to FIG. 1, a document filing system according to the first embodiment of the present invention is comprised of an image input means 101, image display means 102, graphic pattern extraction means 103, command input means 104, information storing means 105, graphic pattern layout classification means 106, and central processing unit 107 serving as a search processing means for controlling these means.

An outline of the operation of each means will be described below.

The image input means 101 inputs the page image information of various types of documents, e.g., drawings and documents. The form of input page image information may be the form of an image sent from a scanner or the form of data read from an image file.

The image display means 102 displays input page image information or a search result.

The graphic pattern extraction means 103 extracts a graphic pattern area from input page image information as a partial image.

The command input means 104 receives inputs from a mouse, keyboard, and the like.

The information storing means 105 stores input page image information and its associated information.

The graphic pattern layout classification means 106 performs layout classification, on the basis of layout classification criteria (layout classifications) defined in advance, according to the positions and sizes of areas from which graphic patterns are extracted by the graphic pattern extraction means 103.

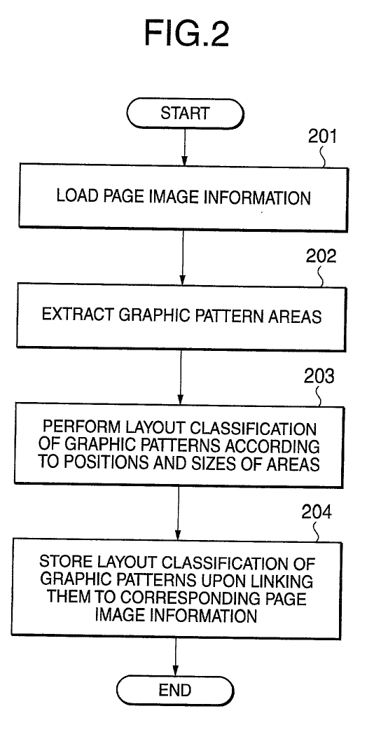

Referring to FIG. 2, processing for the registration of page image information in the document filing system according to the first embodiment is constituted by page image information read step 201, graphic pattern area extraction step 202, graphic pattern layout classification step 203, and graphic pattern layout classification/page image information storage step 204.

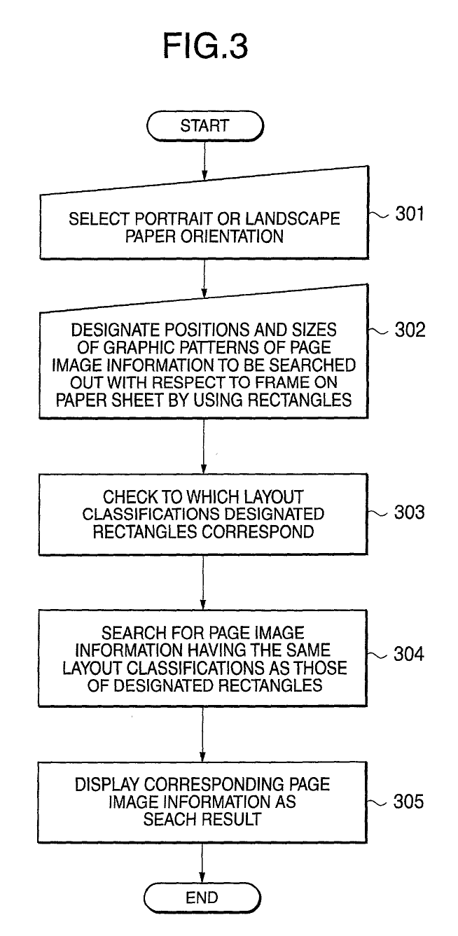

Referring to FIG. 3, processing at the time of a search for page image information in the document filing system according to the first embodiment is constituted by paper portrait/landscape selection step 301, graphic pattern rectangle designation step 302, rectangle layout classification check step 303, page image information search step 304, and search result display step 305.

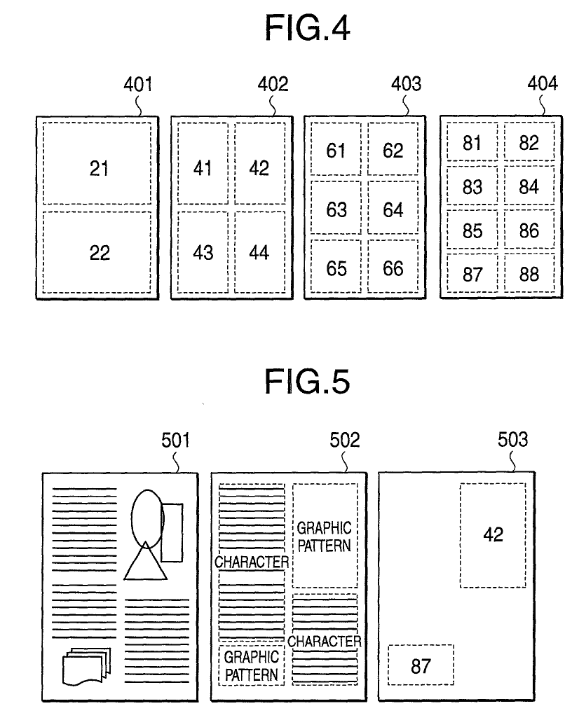

FIG. 4 exemplifies layout classification criteria for graphic patterns when paper sheets are used in portrait orientation. Reference numeral 401 denotes a case where a paper sheet is divided into upper and lower rectangles, and layout classifications “21” and “22” are affixed as labels to the rectangles, respectively; 402, a case where a paper sheet is divided into four rectangles; 403, a case where a paper sheet is divided into six rectangles; and 404, a case where a paper sheet is divided into eight rectangles. In this manner, the graphic pattern layout classification means 106 defines the positions and sizes of areas contained in paper sheets and corresponding labels as layout classification criteria, and performs layout classification of graphic patterns on the basis of the criteria.

The overall operation of the document filing system according to the first embodiment having the above arrangement will be described in detail next with reference to FIGS. 1 to 4.

The operation at the time of registration of page image information will be described first.

First of all, the central processing unit 107 causes the image input means 101 to read the page image information of a document to be registered (step 201).

The central processing unit 107 then causes the graphic pattern extraction means 103 to extract a graphic pattern area as a partial image from the read page image information (step 202).

Subsequently, the central processing unit 107 causes the graphic pattern layout classification means 106 to perform layout classification, on the basis of the layout classification criteria, according to the position and size of the area from which the graphic pattern is extracted (step 203).

Finally, the central processing unit 107 links the layout classification of the graphic pattern as a classification result to the corresponding page image information and stores the layout classification (step 204).

Operation at the time of a search for page image information will be described next.

First of all, the user selects portrait or landscape paper orientation (step 301). The central processing unit 107 causes the command input means 104 to receive the user's operation, and displays a frame on the image display means 102 in accordance with the selected paper orientation.

The user then designates the layout information (position and size) of a graphic pattern contained in page image information to be searched out as a rectangle with respect to the frame of the paper sheet displayed on the image display means 102 by using the command input means 104 such as a mouse (step 302).

The central processing unit 107 then causes the graphic pattern layout classification means 106 to check to which layout classification the designated rectangle corresponds on the basis of the layout classification criteria (step 303).

The central processing unit 107 searches for page image information containing a graphic pattern exhibiting the same layout classification as that of the designated rectangle (step 304).

Finally, the central processing unit 107 causes the image display means 102 to display the page image information containing the graphic pattern corresponding to the same layout classification (step 305).

The above operation will be described in more detail below with reference to a case where page image information 501 shown in FIG. 5 is registered.

First of all, graphic pattern and character areas are separated from each other (see “502” in FIG. 5).

The graphic pattern areas are then extracted, and layout classification of the extracted upper right rectangle and lower left rectangle on the paper sheet is performed on the basis of the layout classification criteria in FIG. 4 according to the positions and sizes of the rectangles. In this case, the two rectangles are classified into layout classifications “87” and “42”, respectively (see “503” in FIG. 5).

Subsequently, layout classifications “87” and “42” of the graphic patterns are linked to the page image information 501 and stored.

Operation to be performed when the page image information 501 is searched out after the above information is stored will be described below.

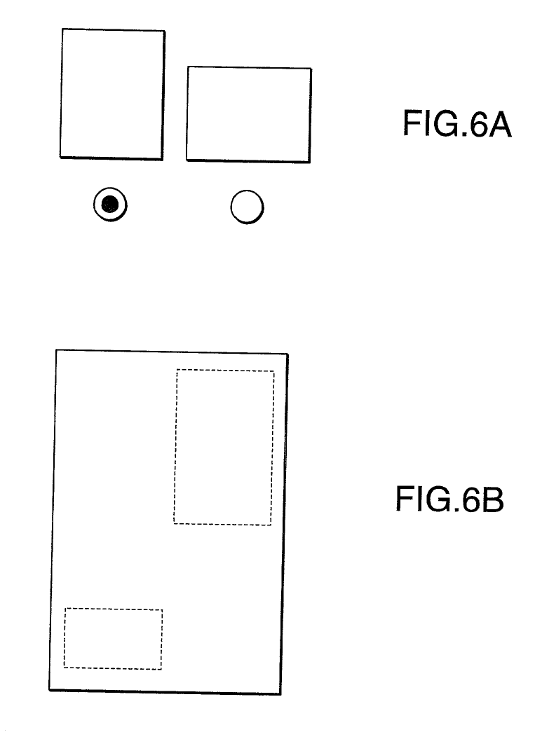

First of all, the user selects portrait orientation as a paper sheet orientation on the paper selection window shown in FIG. 6A. As a consequence, the frame of a paper sheet in portrait orientation is displayed as shown in FIG. 6B. The user then draws an upper right rectangle and lower left rectangle with a keyboard, mouse, or the like, and designates them as search conditions. At this time, layout classification criteria to which labels are affixed as shown in FIG. 4 may be displayed as choices to allow the user to select a layout classification.

The central processing unit 107 recognizes the designated rectangles as layout classifications “87” and “42”, and searches for page image information stored upon being linked to the same layout classifications as layout classifications “87” and “42”.

As a consequence, the page image information 501 is found as page image information that matches the layout classifications of the graphic patterns and is displayed as a search result.

According to the first embodiment, graphic pattern areas are extracted, and layout classification of the graphic patterns is performed according to the positions and sizes of the areas. The layout classifications of the graphic patterns are then stored upon being linked to page image information. When, therefore, the layout information of each graphic pattern on a paper sheet is input as a rectangle in searching for page image information, and each input rectangle is designated as a search condition, page image information stored upon being linked to the same layout classification of the graphic pattern can be extracted as a search result by collating each designated rectangle with the layout classification criteria.

(2) Second Embodiment

The second embodiment of the present invention will be described in detail next with reference to the accompanying drawings.

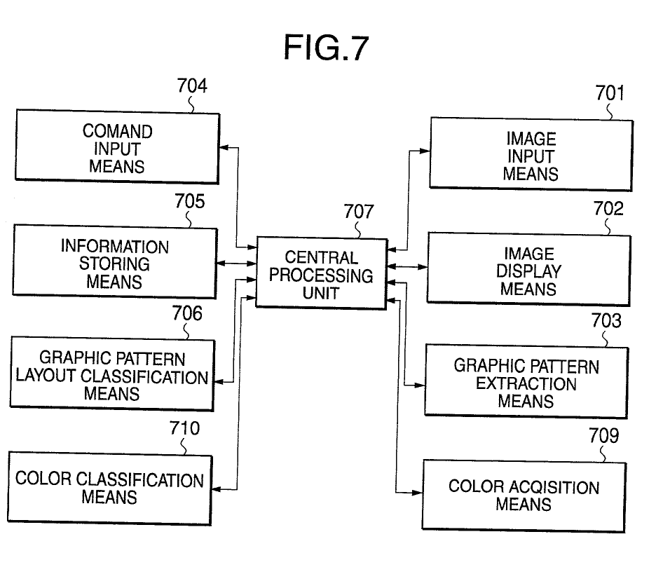

Referring to FIG. 7, a document filing system according to the second embodiment of the present invention has the same arrangement as that of the document filing system according to the first embodiment except that means associated with colors, i.e., a color acquisition means 709 and color classification means 710, are newly added. Since reference numerals 701 to 707 in FIG. 7 denote the same means and the like as the means 101 to 107 in the document filing system according to the first embodiment shown in FIG. 1, a detailed description thereof will be omitted.

The color acquisition means 709 acquires a color representing a graphic pattern. More specifically, this means may use a method of selecting a color that occupies the largest portion of the area of a graphic pattern, a method of defining a fixed rectangle, fitting it in the central portion of a graphic pattern, and selecting a color that occupies the largest area of the rectangle, or the like.

The color classification means 710 classifies the colors acquired by the color acquisition means 709 on the basis of color definition criteria (color definitions) defined in advance. As shown in FIG. 10, colors are limited, and the colors acquired by the color acquisition means 709 are classified by the nearest colors.

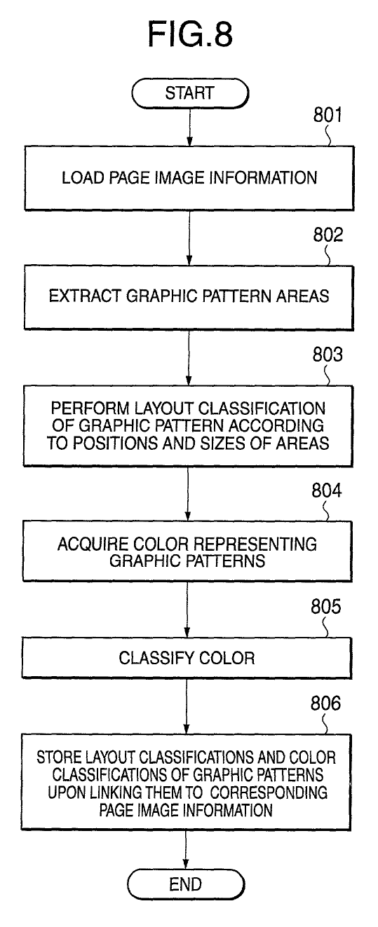

Referring to FIG. 8, processing at the time of registration of page image information in the document filing system according to the second embodiment is constituted by page image information read step 801, graphic pattern area extraction step 802, graphic pattern layout classification step 803, graphic pattern representative color acquisition step 804, color classification step 805, and graphic pattern layout classification/color classification/page image information storage step 806.

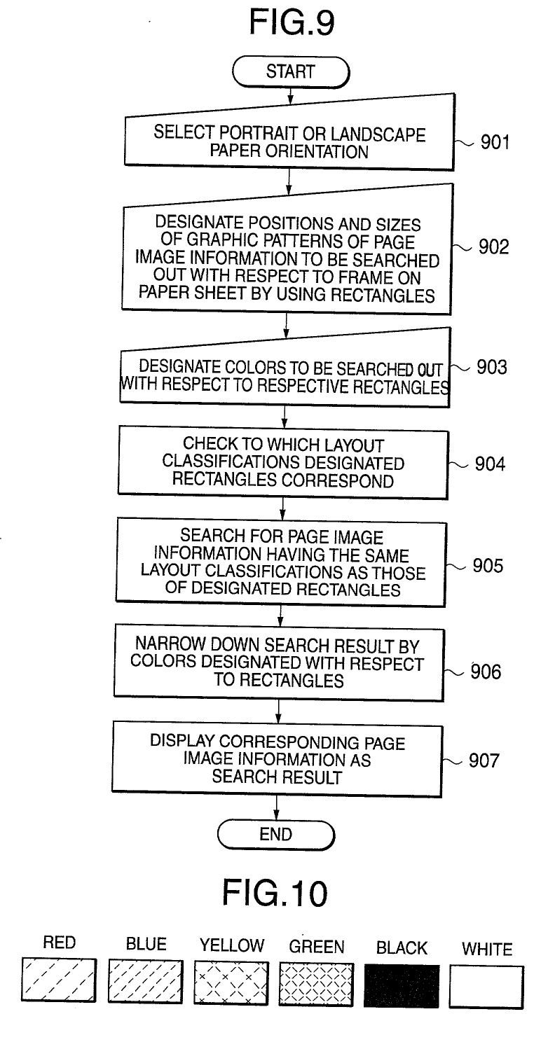

Referring to FIG. 9, processing at the time of a search for page image information in the document filing system according to the second embodiment is constituted by paper portrait/landscape selection step 901, graphic pattern rectangle designation step 902, rectangle color designation step 903, rectangle layout classification check step 904, page image information search step 905, narrow-down step 906 based on designated colors, and search result display step 907.

FIG. 10 is a view exemplifying the color classification criteria used by the color classification means 710 in FIG. 7. In this case, acquired colors are classified into six colors, namely red, blue, yellow, green, black, and white.

The operation of the document filing system according to the second embodiment having the above arrangement will be described in detail below with reference to FIGS. 7 to 10.

Processing in each of steps 801 to 803 in FIG. 8 at the time of registration of page image information is the same as that in each of steps 201 to 203 in FIG. 2, and hence a detailed description thereof will be omitted.

After layout classification of graphic patterns, the central processing unit 707 causes the color acquisition means 709 to acquire colors representing the areas of the extracted graphic patterns (step 804). For example, the color that occupies the largest portion of the area of each extracted graphic pattern is acquired.

The central processing unit 707 then causes the color classification means 710 to classify the colors acquired by the color classification means 710 by collation with color classification criteria such as those shown in FIG. 10 (step 805).

Subsequently, the central processing unit 707 links the graphic pattern layout classification result and color classification result and causes the information storing means 705 to store the data upon linking the data to page image information.

Processing in each of steps 901 and 902 in FIG. 9 at the time of a search for page image information is the same as that of each of steps 301 and 302 in FIG. 3, and hence a detailed description thereof will be omitted.

Upon designating rectangles, the user designates colors to be searched out for the respective rectangles (step 903). Colors may be designated by arbitrarily inputting information or may be selected from the color classification criterion choices in FIG. 10.

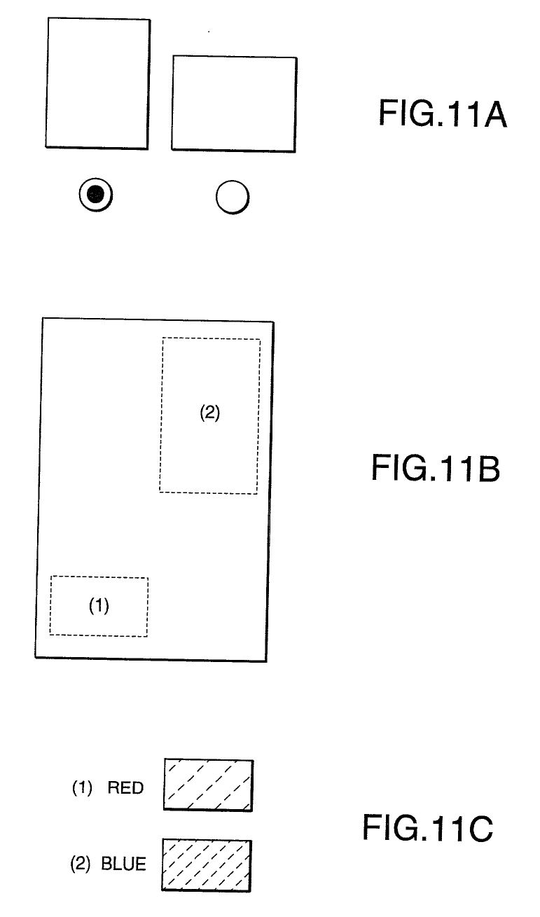

FIGS. 11A to 11C exemplify windows for allowing the user to designate search conditions. First of all, the user selects a portrait paper orientation on a paper selection window like that shown in FIG. 11A. A frame indicating a portrait paper sheet like that shown in FIG. 11B is displayed, and hence the user draws an upper right rectangle and lower left rectangle with the keyboard, mouse, or the like, thereby designating them as search conditions. Subsequently, a color designation window like that shown in FIG. 11C is displayed, and hence the user designates a desired color. At this time, color classification criteria like those shown in FIG. 10 may be displayed as choices to allow the user to select a color classification.

After a search for page image information on the basis of the rectangle layout classification criteria, if a plurality of candidates are searched out, the central processing unit 707 narrows down the search result by designated color classifications (step 906). If the corresponding page image information is present, the image display means 702 displays the information as a search result (step 907).

According to the second embodiment, colors representing graphic patterns are extracted and classified, and the color classifications are stored upon being linked to the layout classifications of the graphic patterns and page image information. In searching for page image information, therefore, the layout information of each graphic pattern on a paper sheet is input as a rectangle, and its color can be designated as a search condition. By collating each input color with classifications, and page image information having the same color classifications can be extracted as a search result.

(2-1) Modification of Second Embodiment

A modification of the second embodiment of the present invention will be described next.

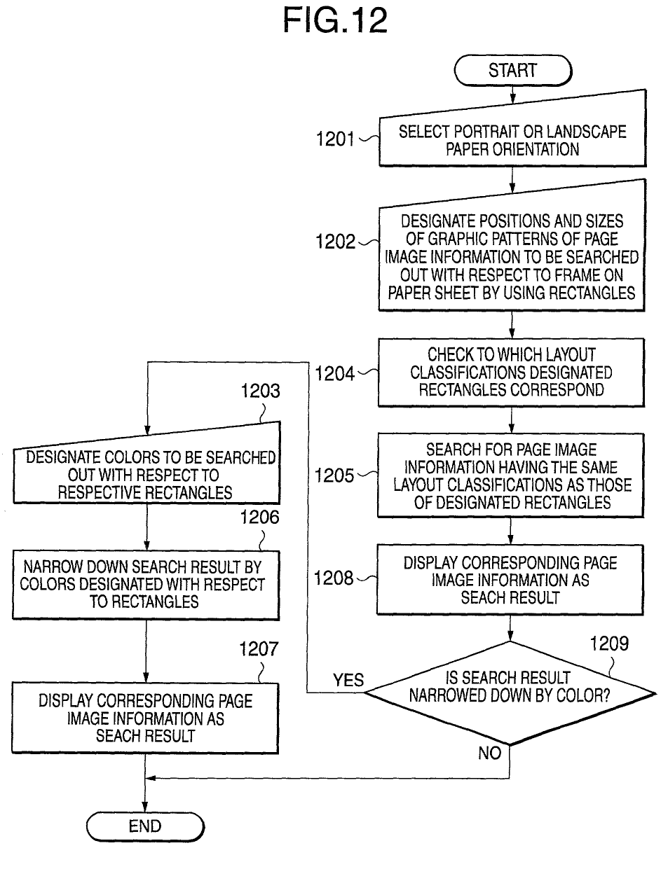

FIG. 12 is a flow chart showing operation at the time of a search for page image information in the modification of the document filing system according to the second embodiment of the present invention. In this case, a search for page image information is performed first by layout classification of graphic patterns. If many pieces of page image information are displayed as a search result, the user can choose to narrow down the candidates by colors.

Steps 1201 to 1207 are the same as steps 901 to 907.

After paper portrait/landscape selection (step 2101) and graphic pattern rectangle designation (step 1202), rectangle layout classification (step 1204) and a search for page image information (step 1205) are performed without any color designation of rectangles. All pieces of page image information as a search result obtained by layout classification of graphic patterns are displayed (step 1208). Thereafter, the user is inquired whether to narrow down by colors (step 1209). If the user chooses to narrow down by colors, the user is made to designate colors to be searched out for the respective rectangles (step 1203), and the pieces of page image information as the search result are narrowed down by the designated colors of the rectangles (step 1206). The corresponding pieces of page image information are then displayed as a search result (step 1207).

As described above, after pieces of page image information as a search result by layout classification of graphic patterns are displayed, the user is allowed to choose whether to narrow down the information by colors. This makes it possible to reduce search processing for graphic patterns when there is no need to narrow down the information by colors.

Assume that a character recognition technique is combined with the document filing system according to each of the first and second embodiments. In this case, after graphic pattern and character areas are separated, automatic character recognition can be executed for each character area to store the recognition result upon linking it to the page image information. With this operation, since full-text search targets can be narrowed down by the first-stage narrow-down operation performing layout classification of graphic patterns and a search by color classification, the time taken for the execution of a full-text search can be shortened. In addition, in combination with other conventional search methods based on keywords, each of the search techniques according to the first and second embodiments can be used as a first-stage narrow-down technique.

(3) Third Embodiment

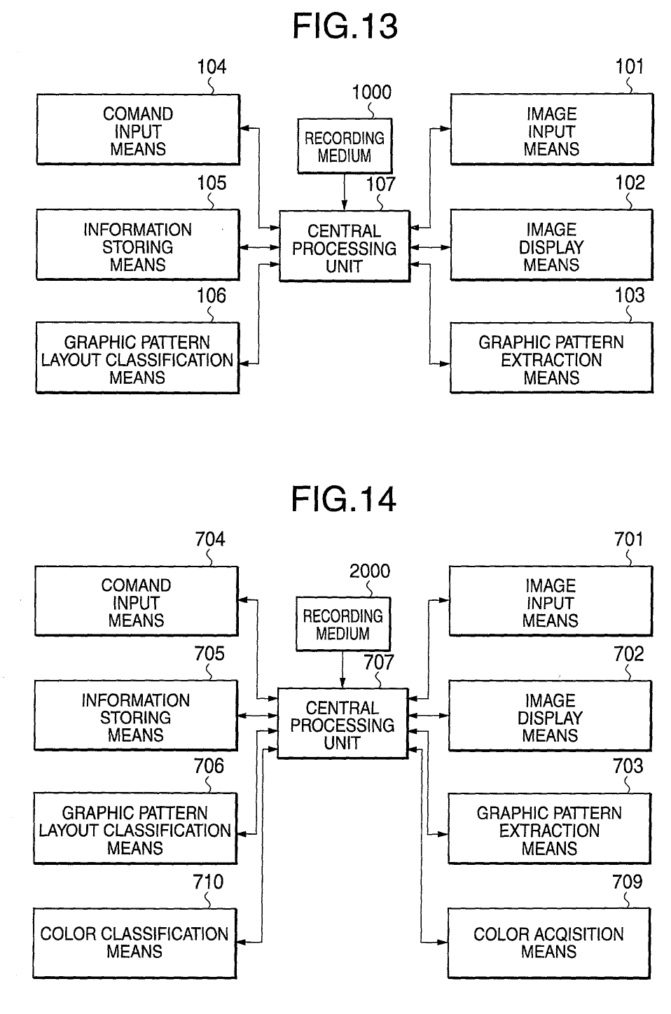

FIG. 13 is a block diagram showing the arrangement of a document filing system according to the third embodiment of the present invention.

Referring to FIG. 13, in the document filing system according to the third embodiment, a recording medium 1000 on which a document filing program is recorded is connected to the central processing unit 107 of the document filing system according to the first embodiment shown in FIG. 1. This recording medium 1000 may be a magnetic disk, semiconductor memory, or another recording medium.

The document filing program is loaded from the recording medium 1000 into a central processing unit 107 to control the operation of the central processing unit 107 and the operations of accompanying means, i.e., an image input means 101, image display means 102, graphic pattern extraction means 103, command input means 104, information storing means 105, and graphic pattern layout classification means 106. Since the operations (processing contents) of the central processing unit 107 controlled by the document filing program and accompanying means, i.e., the image input means 101, image display means 102, graphic pattern extraction means 103, command input means 104, information storing means 105, and graphic pattern layout classification means 106 are the same as those in the flow charts of FIGS. 2 and 3, a detailed description thereof will be omitted.

(4) Fourth Embodiment

FIG. 14 is a block diagram showing the arrangement of a document filing system according to the fourth embodiment of the present invention.

Referring to FIG. 14, in the document filing system according to the fourth embodiment, a recording medium 2000 on which a document filing program is recorded is connected to the central processing unit 707 in the document filing system according to the second embodiment shown in FIG. 7. This recording medium 2000 may be a magnetic disk, semiconductor memory, or another recording medium.

The document filing program is loaded from the recording medium 2000 into a central processing unit 707 to control the operation of the central processing unit 707 and the operations of accompanying means, i.e., an image input means 701, image display means 702, graphic pattern extraction means 703, command input means 704, information storing means 705, graphic pattern layout classification means 706, color acquisition means 709, and color classification means 710. Since the operations (processing contents) of the central processing unit 707 controlled by the document filing program and accompanying means, i.e., the image input means 701, image display means 702, graphic pattern extraction means 703, command input means 704, information storing means 705, graphic pattern layout classification means 706, color acquisition means 709, and color classification means 710 are the same as those in the flow charts of FIGS. 8 and 9 (or FIG. 12), a detailed description thereof will be omitted.

What is claimed is:

1. A document filing system comprising:
(a) image input means for inputting page image information of a document;
(b) graphic pattern extraction means for extracting a graphic pattern area from the page image information input by said image input means;
(c) graphic pattern layout classification means for classifying the graphic pattern area extracted by said graphic pattern extraction means on the basis of layout classification criteria defined in advance;
(d) information storing means for storing a layout classification classified by said graphic pattern layout classification means upon linking the layout classification to the page image information input by said image input means;
(e) command input means for giving a command to search for page image information by designating layout information of a graphic pattern in the page image information as a rectangle in a frame on a paper sheet;
(f) search processing means for classifying the rectangle in the frame on the paper sheet, which is designated by said command input means, on the basis of the layout classification criteria, and searching for page image information stored upon being linked to the same layout classification; and
(g) image display means for displaying the page image information searched out by said search processing means.

2. A document filing system comprising:
(a) image input means for inputting page image information of a document;
(b) graphic pattern extraction means for extracting a graphic pattern area from the page image information input by said image input means;
(c) graphic pattern layout classification means for classifying the graphic pattern area extracted by said graphic pattern extraction means on the basis of layout classification criteria defined in advance;
(d) color acquisition means for acquiring a representative color from the graphic pattern area extracted by said graphic pattern extraction means;
(e) color classification means for classifying the color from said color acquisition means on the basis of color criteria defined in advance;
(f) information storing means for linking a layout classification obtained by said graphic pattern layout classification means to a color classification obtained by said color classification means and storing the classifications upon linking the classifications to the page image information input by said image input means;
(g) command input means for giving a command to search for page image information by designating layout information of a graphic pattern in the page image information as a rectangle in a frame on a paper sheet, and also designating a color for a search with respect to the designated rectangle on the basis of the color criteria;
(h) search processing means for classifying the rectangle in the frame on the paper sheet, which is designated by said command input means, on the basis of the layout classification criteria, searching for page image information stored upon being linked to the same layout classification, and narrowing down the page image information as a search result depending on whether the information is stored upon being linked to the same color classification as that of the color designated by said command input means; and
(i) image display means for displaying the page image information narrowed down by said search processing means.

3. A document filing system comprising:
(a) image input means for inputting page image information of a document;
(b) graphic pattern extraction means for extracting a graphic pattern area from the page image information input by said image input means;
(c) graphic pattern layout classification means for classifying the graphic pattern area extracted by said graphic pattern extraction means on the basis of layout classification criteria defined in advance;
(d) color acquisition means for acquiring a representative color from the graphic pattern area extracted by said graphic pattern extraction means;
(e) color classification means for classifying the color from said color acquisition means on the basis of color criteria defined in advance;
(f) information storing means for linking a layout classification obtained by said graphic pattern layout classification means to a color classification obtained by said color classification means and storing the classifications upon linking the classifications to the page image information input by said image input means;
(g) first command input means for giving a command to search for page image information by designating layout information of a graphic pattern in the page image information as a rectangle in a frame on a paper sheet;
(h) first search processing means for classifying the rectangle in the frame on the paper sheet, which is designated by said first command input means, on the basis of the layout classification criteria, and searching for page image information stored upon being linked to the same layout classification;
(i) first image display means for displaying the page image information searched out by said first search processing means;
(j) second input means for inquiring whether to narrow down the page image information displayed by said first image display means by colors, and if the information is to be narrowed down by colors, giving a command to narrow down the page image information by designating a color to be searched out with respect to each rectangle on the basis of the color classification criteria;
(k) second search processing means for narrowing down the page image information searched out by said first search processing means depending on whether the information is stored upon being linked to the same color classification as that of each rectangle designated by said second command input means; and
(l) second image display means for displaying the page image information narrowed down by said second search processing means.

4. A system according to claim 1, further comprising means for selecting a portrait/landscape orientation of the paper sheet at the time of a search for the page image information.

5. A system according to claim 2, further comprising means for selecting a portrait/landscape orientation of the paper sheet at the time of a search for the page image information.

6. A system according to claim 3, further comprising means for selecting a portrait/landscape orientation of the paper sheet at the time of a search for the page image information.

7. A document filing method comprising:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the information storing step of storing a layout classification from the graphic pattern layout classification step upon linking the layout classification to the page image information input in the image input step;
(e) the command input step of giving a command to search for page image information by designating layout information of a graphic pattern in the page image information as a rectangle in a frame on a paper sheet;
(f) the search processing step of classifying the rectangle in the frame on the paper sheet, which is designated in the command input step, on the basis of the layout classification criteria, and searching for page image information stored upon being linked to the same layout classification; and
(g) the image display step of displaying the page image information searched out in the search processing step.

8. A document filing method comprising:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the color acquisition step of acquiring a representative color from the graphic pattern area extracted in the graphic pattern extraction step;
(e) the color classification step of classifying the color from the color acquisition step on the basis of color criteria defined in advance;
(f) the information storing step of linking a layout classification obtained in the graphic pattern layout classification step to a color classification obtained in the color classification step and storing the classifications upon linking the classifications to the page image information input in the image input step;
(g) the command input step of giving a command to search for page image information by designating layout information of a graphic pattern in the page image information as a rectangle in a frame on a paper sheet, and also designating a color for a search with respect to the designated rectangle on the basis of the color criteria;
(h) the search processing step of classifying the rectangle in the frame on the paper sheet, which is designated in the command input step, on the basis of the layout classification criteria, searching for page image information stored upon being linked to the same layout classification, and narrowing down the page image information as a search result depending on whether the information is stored upon being linked to the same color classification as that of the color designated in the command input step; and
(i) the image display step of displaying the page image information narrowed down in the search processing step.

9. A document filing method comprising:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the color acquisition step of acquiring a representative color from the graphic pattern area extracted in the graphic pattern extraction step;
(e) the color classification step of classifying the color from the color acquisition step on the basis of color criteria defined in advance;
(f) the information storing step of linking a layout classification obtained in the graphic pattern layout classification step to a color classification obtained in the color classification step and storing the classifications upon linking the classifications to the page image information input in the image input step;
(g) the first command input step of giving a command to search for page image information by designating layout information of a graphic pattern in the page image information as a rectangle in a frame on a paper sheet;
(h) the first search processing step of classifying the rectangle in the frame on the paper sheet, which is designated in the first command input step, on the basis of the layout classification criteria, and searching for page image information stored upon being linked to the same layout classification;
(i) the first image display step of displaying the page image information searched out in the first search processing step;
(j) the second input step of inquiring whether to narrow down the page image information displayed in the first image display step by colors, and if the information is to be narrowed down by colors, giving a command to narrow down the page image information by designating a color to be searched out with respect to each rectangle on the basis of the color classification criteria;
(k) the second search processing step of narrowing down the page image information searched out in the first search processing step depending on whether the information is stored upon being linked to the same color classification as that of each rectangle designated in the second command input step; and
(l) the second image display step of displaying the page image information narrowed down in the second search processing step.

10. A method according to claim 7, further comprising the step of selecting a portrait/landscape orientation of the paper sheet at the time of a search for the page image information.

11. A method according to claim 8, further comprising the step of selecting a portrait/landscape orientation of the paper sheet at the time of a search for the page image information.

12. A method according to claim 9, further comprising the step of selecting a portrait/landscape orientation of the paper sheet at the time of a search for the page image information.

13. A recording medium on which a program is recorded, the program causing a computer to execute:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the information storing step of storing a layout classification from the graphic pattern layout classification step upon linking the layout classification to the page image information input in the image input step;
(e) the command input step of giving a command to search for page image information by designating layout information of a graphic pattern in the page image information as a rectangle in a frame on a paper sheet;
(f) the search processing step of classifying the rectangle in the frame on the paper sheet, which is designated in the command input step, on the basis of the layout classification criteria, and searching for page image information stored upon being linked to the same layout classification; and
(g) the image display step of displaying the page image information searched out in the search processing step.

14. A recording medium on which a program is recorded, the program causing a computer to execute:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the color acquisition step of acquiring a representative color from the graphic pattern area extracted in the graphic pattern extraction step;
(e) the color classification step of classifying the color from the color acquisition step on the basis of color criteria defined in advance;
(f) the information storing step of linking a layout classification obtained in the graphic pattern layout classification step to a color classification obtained in the color classification step and storing the classifications upon linking the classifications to the page image information input in the image input step;
(g) the command input step of giving a command to search for page image information by designating layout information of a graphic pattern in the page image information as a rectangle in a frame on a paper sheet, and also designating a color for a search with respect to the designated rectangle on the basis of the color criteria;
(h) the search processing step of classifying the rectangle in the frame on the paper sheet, which is designated in the command input step, on the basis of the layout classification criteria, searching for page image information stored upon being linked to the same layout classification, and narrowing down the page image information as a search result depending on whether the information is stored upon being linked to the same color classification as that of the color designated in the command input step; and
(i) the image display step of displaying the page image information narrowed down in the search processing step.

15. A recording medium on which a program is recorded, the program causing a computer to execute:
(a) the image input step of inputting page image information of a document;
(b) the graphic pattern extraction step of extracting a graphic pattern area from the page image information input in the image input step;
(c) the graphic pattern layout classification step of classifying the graphic pattern area extracted in the graphic pattern extraction step on the basis of layout classification criteria defined in advance;
(d) the color acquisition step of acquiring a representative color from the graphic pattern area extracted in the graphic pattern extraction step;
(e) the color classification step of classifying the color from the color acquisition step on the basis of color criteria defined in advance;
(f) the information storing step of linking a layout classification obtained in the graphic pattern layout classification step to a color classification obtained in the color classification step and storing the classifications upon linking the classifications to the page image information input in the image input step;
(g) the first command input step of giving a command to search for page image information by designating layout information of a graphic pattern in the page image information as a rectangle in a frame on a paper sheet;
(h) the first search processing step of classifying the rectangle in the frame on the paper sheet, which is designated in the first command input step, on the basis of the layout classification criteria, and searching for page image information stored upon being linked to the same layout classification;
(i) the first image display step of displaying the page image information searched out in the first search processing step;
(j) the second input step of inquiring whether to narrow down the page image information displayed in the first image display step by colors, and if the information is to be narrowed down by colors, giving a command to narrow down the page image information by designating a color to be searched out with respect to each rectangle on the basis of the color classification criteria;
(k) the second search processing step of narrowing down the page image information searched out in the first search processing step depending on whether the information is stored upon being linked to the same color classification as that of each rectangle designated in the second command input step; and
(l) the second image display step of displaying the page image information narrowed down in the second search processing step.

16. A medium according to claim 13, wherein a program for further executing the step of selecting a portrait/landscape orientation of the paper sheet at the time of a search for the page image information is recorded on the recording medium.

17. A medium according to claim 14, wherein a program for further executing the step of selecting a portrait/landscape orientation of the paper sheet at the time of a search for the page image information is recorded on the recording medium.

18. A medium according to claim 15, wherein a program for further executing the step of selecting a portrait/landscape orientation of the paper sheet at the time of a search for the page image information is recorded on the recording medium.
